(19) United States
(12) Patent Application Publication
(10) Pub. No.: US 2016/0353777 A1
(43) Pub. Date: Dec. 8, 2016

(54) USE OF SAPONINS TO REPLACE EGG WHITES IN ALCOHOLIC AND NON-ALCOHOLIC BEVERAGES

(71) Applicant: Larrian Gillespie, Los Angeles, CA (US)

(72) Inventor: Larrian Gillespie, Los Angeles, CA (US)

(21) Appl. No.: 15/165,390

(22) Filed: May 26, 2016

Related U.S. Application Data
(60) Provisional application No. 62/167,536, filed on May 28, 2015.

(51) Int. Cl. A23G 9/00; A23L 2/52; C12G 3/00; A23G 9/04

(52) U.S. Cl. CPC A23L 1/3216; C12G 3/00; A23G 9/04; A23L 2/52; A23V 2002/00

(57) ABSTRACT

A method for creating a foam in alcoholic and non-alcoholic beverages. The method includes providing a recipe for a beverage that includes egg whites as an ingredient. The method also includes preparing the non-egg white portion of the beverage according to the recipe. The method further includes adding a compound containing saponins to the beverage. The method additionally includes agitating the beverage. The foam incorporates portions of the liquid of the beverage.

### CROSS-REFERENCE TO RELATED APPLICATIONS

This application claims the benefit of and priority to U.S. Provisional Patent Application Ser. No. 62/167,536 filed on May 28, 2015, which application is incorporated herein by reference in its entirety.

### BACKGROUND OF THE INVENTION

Use of raw egg whites in recipes creates unique properties. However, their use is also problematic. In particular, they can carry disease or cause allergic reactions. Because of these potential problems, increasing numbers of restaurants and other food providers are removing egg whites from food that they serve or sell.

Accordingly, there is a need in the art for an egg white substitute that provides the desired properties without the associated health risks.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for creating a foam in alcoholic and non-alcoholic beverages. The method includes providing a recipe for a beverage that includes egg whites as an ingredient. The method also includes preparing the non-egg white portion of the beverage according to the recipe. The method further includes adding a compound containing saponins to the beverage. The method additionally includes agitating the beverage. The foam incorporates portions of the liquid of the beverage.

Another example embodiment includes a method for creating stencils on a foam. The method includes creating a foam in a beverage using saponins. The method also includes placing a stencil on or near the foam. The method further includes applying a pigment to the stencil image.

Another example embodiment includes a method for creating ice cream. The method includes preparing an ice cream base. The method also includes adding a compound containing saponins to the ice cream base. The method further includes freezing the ice cream base while stirring.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating an example of a method of using saponins as a foaming agent;

FIG. 2 illustrates an example of Quillaja saponaria;

FIG. 3 is a flowchart illustrating an example of a method of using saponins as an emulsion foaming agent in a sauce or condiment;

FIG. 4 is a flowchart illustrating an example of a method of using saponins to create an image from a stencil on foam; and

FIG. 5 is a flowchart illustrating an example of a method of creating an ice cream using saponins.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

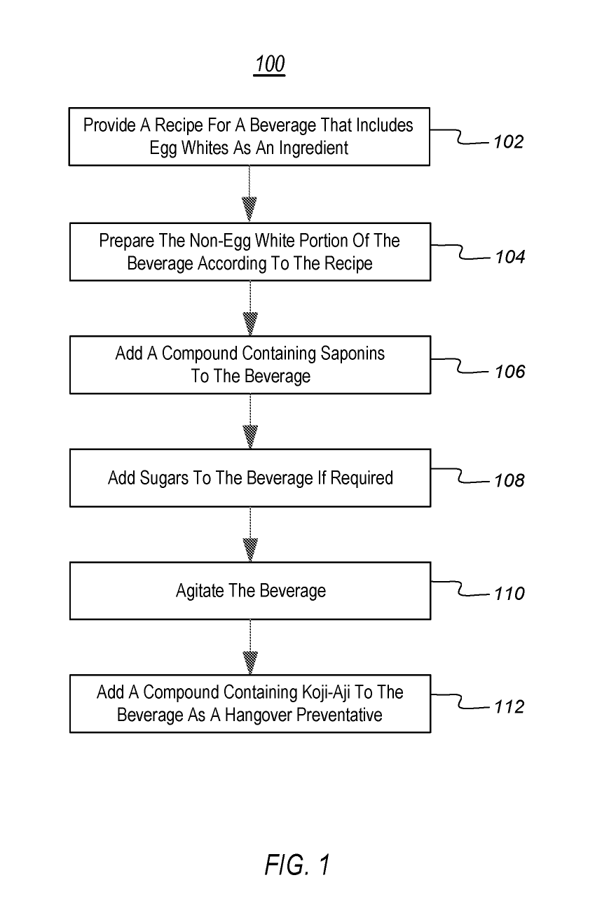

FIG. 1 is a flowchart illustrating an example of a method 100 of using saponins as a foaming agent. In particular, saponins can be used as a substitute for egg whites or other materials that are used as foaming agents in beverages or foods.

FIG. 1 shows that the method 100 can include providing 102 a recipe for a beverage that includes egg whites as an ingredient. The beverage can be either alcoholic or non-alcoholic and can include hot or cold beverages. For example, the recipe can include cocktail recipes, mocktails, beers, coffee, cappuccino, or any other desired beverage.

Alcoholic drinks, such as the Pisco Sour, Ramos Gin Fizz, sours, silvers and fizzes, which include more than 100 drinks, rely upon egg whites to create a stable foam and give an enriching mouthfeel to a drink. However, food allergies and fears of bacterial contamination with salmonella resulting in food poisoning have nearly eliminated these drinks from bars and restaurants due to liability issues. Pregnant women and others with immune compromised systems avoid egg whites because of bacterial infection and immune responses to the fetus. The protein ovalbumin is a tightly wound molecule that, when shaken, unravels. It requires an acidic environment to stabilize the protein, which inhibits it from binding to other proteins, resulting in smaller bubbles and a better foam. However, the stability of the foam is usually no more than a few minutes. Dry powdered egg whites have been used with less success due to the mouthfeel and difficulty dissolving in alcoholic solutions.

Egg white is the common name for the clear liquid (also called the albumen or the glair/glaire) contained within an egg. In chickens it is formed from the layers of secretions of the anterior section of the hen's oviduct during the passage of the egg. It forms around fertilized or unfertilized egg yolks. The primary natural purpose of egg white is to protect the yolk and provide additional nutrition for the growth of the embryo (when fertilized). Egg white consists primarily of about 90% water into which is dissolved 10% proteins (including albumins, mucoproteins, and globulins). Unlike the yolk, which is high in lipids (fats), egg white contains almost no fat, and carbohydrate content is less than 1%. Egg whites contain just over 50% of the protein in the egg.

The physical stress of beating egg whites can create a foam. Two types of physical stress are caused by beating them with a whisk, the first of which occurs as the whisk drags the liquid through itself, creating a force that unfolds the protein molecules. This process is called denaturation. The second stress comes from the mixing of air into the whites, which causes the proteins to come out of their natural state. These denatured proteins gather together where the air and water meet and create multiple bonds with the other unraveled proteins, and thus become a foam, holding the incorporated air in place.

FIG. 1 also shows that the method 100 can include preparing 104 the non-egg white portion of the beverage according to the recipe. That is, all portions of the recipe other than the egg whites remain unchanged. One of skill in the art will appreciate that not all egg whites need to be removed. Thus, the method can be used with any desired recipe that contains egg whites without changing the taste or texture of the beverage (although the foam may be improved, as discussed below).

FIG. 1 further shows that the method 100 can include adding 106 a compound containing saponins to the beverage. The compound can include any desired saponins. For example, Quillaja extract (also China bark extract, Murillo bark extract, Panama bark extract, Quillai extract, Quillaia extract, Quillay bark extract, Soapbark extract, sea cucumber, Aesculus hippocastanum, Ceanothus cuneatus, Chlorogalum pomeridianum, Lychnis flos-cuculi, Philadelphus lewisii, Pteridium aquilinum, Saponaria officinalis and Yucca schidigeraamong other names) can be used as the foaming agent. For instance, the compound can include a mixture with between 25-50% w/w Quillaja saponaria extract soluble solids, between 0-25% w/w invert sugar as a carrier, between 50-75% w/w water and approximately 0.1% w/w sodium benzoate (food grade) as a preservative. The amount of compound to be added depends on the concentration of saponins within the compound. For example, if the compound is as described above then 1-2 drops are added per egg white in the original recipe of the beverage. That is, for each egg white which was called for in the recipe, 1-2 drops of the compound can be added as a substitute for the egg white. For example, if 4 egg whites are called for in the recipe then 2 egg whites and 4 drops of the compound containing saponins can be used. As used in the specification and the claims, the term approximately shall mean that the value is within 10% of the stated value, unless otherwise specified.

Saponins eliminate the danger of bacterial contamination while providing the essential mouthfeel of the texture of egg whites while creating a foam. Quillaja disperses instantly without the need for hydration and works in a broad range of pH and temperature, unlike egg whites which congeal at 142 F and solidify at 184 F and become unstable in basic or alkaline pH.

Saponins stabilize the air/water interface of bubbles, by preventing coalescence of the bubbles. Saponins prevent Ostwald forces from aggregating and building larger bubbles which rise to the surface according to Stoke's law, where gravity drains liquid from in-between bubble walls leading to collapse. Saponins work by creating smaller bubbles which rise slowly and have less force to coalesce, resulting in a stable, long lasting foam up to several hours.

Saponins are a diverse group of compounds widely distributed in the plant kingdom, which are characterized by their structure, which contains a triterpene or steroid aglycone and one or more sugar chains. They have been used as immunostimulants as part of non-particle adjuvants in vaccines, due to their strong immunomodulator effect.

Saponins are derived from plants and are amphipathic glycosides structurally containing one or more hydrophilic glycoside moities combined with a lipophilic triterpene derivative, which allows for fats to be incorporated easily into an emulsion in their presence. They are also known for their ability to act as a surfactant, creating soap-like foaming responses when shaken in an aqueous solution.

Yucca schidigera, a saponin, contains a steroid nucleus, while Quillaja saponaria contains a triterpenoid nucleus. As a result of their surface active properties, saponins are excellent foaming agents, and are used in beverages to provide a foamy head.

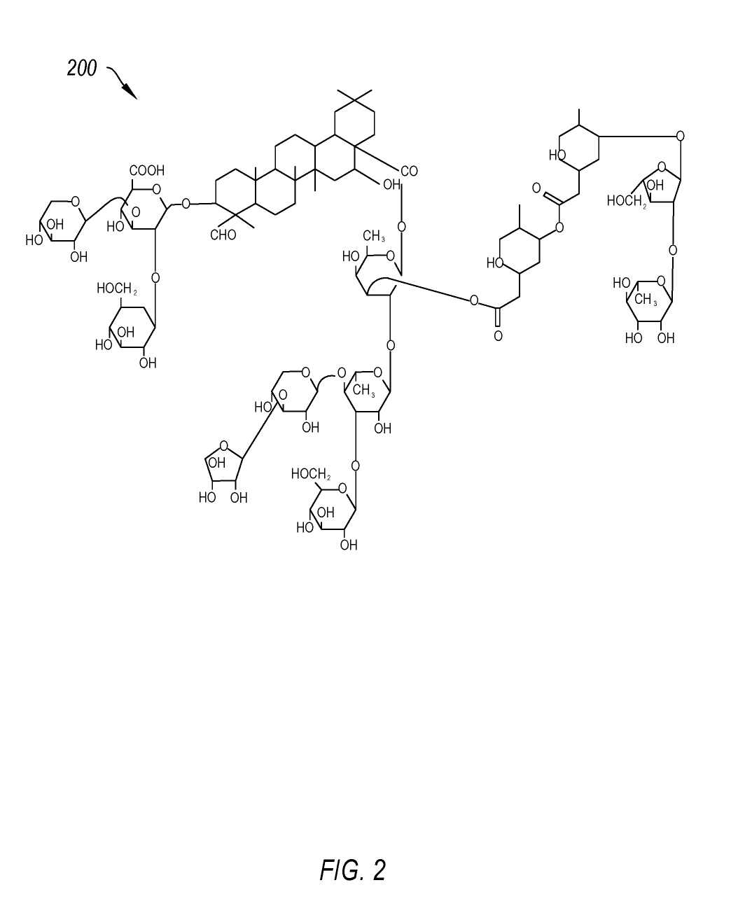

Quillaja extract contains over 100 triterpenoid saponins, consisting predominantly of glycosides of quillaic acid. Polyphenols and tannins are also major components. Some simple sugars and calcium oxalate are also present in the extract. Quillaja triterpenic saponins are non-ionic surfactants, resistant to salt, heat, and extremely stable to acid pH. They consist of a five-ringed quillaic acid backbone with small carbohydrate chains, consisting of two to five sugar units, attached at the 3′ and 28′ carbons of quillaic acid and are frequently branched (FIG. 2). Attached to the first sugar (fucose) unit of the carbohydrate chain, at the 28′ position, there is a 18 carbon atoms acyl chain with a small carbohydrate chain at its terminal end, which consists of one or two sugar units. The substitution of different sugar chains gives rise to at least 50 different types of quillaja triterpenic saponins. Their average molecular weight is 1800-2000 Dalton. Below 200-500 ppm concentration, saponins exist as monomers. Above such level, they aggregate to form micelles, with an apparent molecular weight of approximately 100,000 Dalton.

FIG. 1 moreover shows that the method 100 can include adding 108 sugars to the beverage, if required. The more sugars present in the beverage, the greater the foaming response. Therefore, if the sugar content is low, then syrup or other sugar sources may be added to increase the foaming reaction. However, if the sugar content is high then additional sugar may not be required.

FIG. 1 additionally shows that the method 100 can include agitating 110 the beverage. Agitating can include shaking, stirring, pouring from a height, bubbling, blending or any other method that is configured to add air or other gases to the beverage. For example, pouring a carbonated beverage from an increased height can increase the amount of foam. Agitating 110 creates a foam which incorporates the beverage mixture, giving the foam a taste that is similar to the beverage. One of skill in the art will appreciate that agitating need not occur immediately after preparation of the beverage. For example, the beverage can be prepared and frozen. After thawing agitation can occur to create the desired foaming.

FIG. 1 also shows that the method 100 can include adding 112 a compound containing Koji-Aji to the beverage as a hangover preventative. In particular, the Koji-Aji and the saponins together act to prevent a hangover. One of skill in the art will appreciate that the compound containing Koji-Aji and the compound containing saponins can be added as a single step. That is, there can be a single compound that contains both Koji-Aji and saponins which is added as both a foaming agent and a hangover preventative.

Intoxication from alcohol poses a number of negative consequences, one of which is a hangover, or symptoms of headache, fatigue, dehydration, sleep disturbance, poor sense of well-being and anxiety. It takes, on average, three alcoholic beverages a day for a woman to experience a hangover and five for a male. The mechanisms behind the causation of a hangover are not totally understood but elements such as congeners, which are byproducts of fermentation such as aldehydes, esters and acids from higher alcohols, can affect the metabolism of alcohol in the liver resulting in elevated blood ammonia levels. Acetaldehyde is created when alcohol is broken down by alcohol dehydrogenase, which is then broken down further by glutathione and acetaldehyde dehydrogenase into nontoxic acetate. Alcohol is metabolized at the rate of 0.015 of blood alcohol concentration (BAC) every hour in a normal person.

The liver's stores of glutathione run out quickly when larger amounts of alcohol are consumed, which leads to a buildup of acetaldehyde and ammonia. Women in particular have less liver glutathione and acetaldehyde dehydrogenase than men, making them particularly susceptible to the creation of a hangover.

Succinic acid is important in alcohol metabolism as it boosts the aerobic oxidation process in the mitochondria of the liver by activating the second half cycle of tricarboxilic acid production in the Krebs cycle. Succinic substrates prevent the toxic byproducts of ethanol metabolism from causing intracellular hypoxia, acidosis and from impeding NADH oxidation in the respiratory function of cells (the Krebs cycle). In addition, succinic acid stimulates salivation.

Glutamic Acid speeds up the malate-aspartate cycle in the cytosol of the mitochondria, which speeds up the succinate oxidation process by preventing oxalic acid and acetic acid blocking of succinate dehydrogenase. Reduced forms of glutamate or glutamic acid are produced as glutathione in the liver.

Saponins, especially triterpenoid saponins such as Quillaja, contain a lipophilic nucleus and one or more water soluble carbohydrate side chains. Saponins can create micelles around congeners, reducing the available aldehydes and slowing down their absorption in the gut. The critical micelle concentration and aggregation number for saponins is affected by salt concentration. As the salt concentration increases in an aqueous solution, the size and aggregation properties of Quillaja micelles decrease.

Hangovers produce a loss of sodium, potassium and other minerals in the body through diuresis from alcohol's blocking effect on vasopressin, the antidiuretic hormone. Drinking 250 ml of an alcoholic beverage can cause the body to expel 800 to 1000 ml of water. The average cocktail volume is 4-6 ounces, or 118-177 ml. Consuming more than one cocktail can result in significant loss of water, minerals and salts.

Koji-Aji is a kokumi-imparting flavor additive which contains gamma glutamyl nucleotides, which are a reduced form of glutathione, amino acids and peptides derived from fermented wheat gluten and a proprietary nucleotide yeast extract, and is produced by the Anjinomoto Company. In addition to prolonging the flavor experience, Koji-Aji has the ability to impart saltiness in the presence of very low sodium. Combining Koji-Aji, succinic acid, a salt and a saponin together while ingesting an alcoholic beverage, can result in decreasing the symptoms of a hangover. This combination can be applied into a beverage directly or taken as a tablet or other form of suitable ingestion at any time, but most ideally combined with the alcoholic beverage.

Ratios as low as 3% sodium chloride can be used and not affect the micellar integrity of the Quillaja saponin, and 1% succinic acid is sufficient to boost the aerobic oxidation cycle in the liver. Ideally the formula would contain 1% Koji-Aji, 1% sodium/potassium chloride (sea salt) and 1% succinic acid to 1 ml of Quillaja extract of a 50% concentration. This formula can be varied according to need, but should be incorporated into 120 ounces of an alcoholic beverage.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

By way of example, the method 100 of FIG. 1 can be used to create a Ramos Gin Fizz. 2 drops of Quillaja extract, 2 oz gin, ½ oz lime juice, ½ oz lemon juice, 1 oz heavy cream, 2 tsp fine sugar, % tsp orange flower water and ice are added to a shaker. The mixture is shaken for 25 seconds and pour into a chilled 10-ounce highball glass and soda water is added. The foam will last 4 hours and the flavor of the drink is incorporated into the foam, unlike egg white which does not retain the flavor of the drink. The same recipe with the gin eliminated can be used to create a mocktail with a foam on top that is flavored by the remaining components of the drink.

Hot drinks can be prepared according the method 100 of FIG. 1 without having to prepare the foam separately. For example, an egg sour hot toddy can be made with 2 drops of Quillaja saponaria extract added to all the ingredients in the shaker. Unlike standard hot toddies, which require the egg white foam to be prepared separately from the shaken ingredients, Quillaja saponaria incorporates the flavor of the drink into the foam and increases the convenience of making a drink.

FIG. 2 illustrates an example of Quillaja saponaria 200. One of skill in the art will appreciate that there are multiple types of Quillaja saponaria and that for the methods illustrated herein, any saponin can be used. Thus, FIG. 2 is meant to be illustrative only and not limiting.

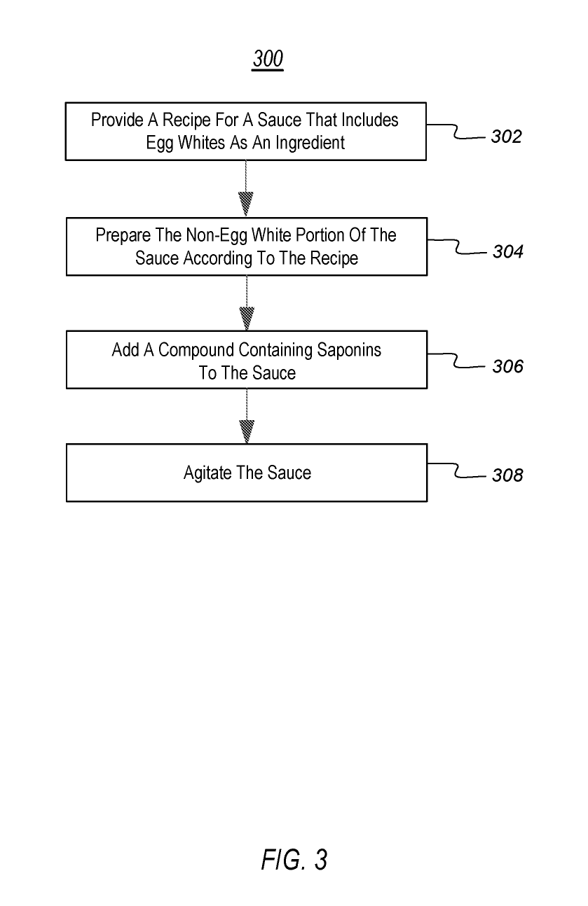

FIG. 3 is a flowchart illustrating an example of a method 300 of using saponins as an emulsion foaming agent in a sauce or condiment. In particular, saponins can be used as a substitute for at least some of the egg whites or egg yolks in sauces or condiments, such as mayonnaise, hollandaise, béarnaise or other egg based sauces or condiments.

FIG. 3 shows that the method 300 can include providing 302 a recipe for a sauce that includes egg whites as an ingredient. The sauce can be either raw or cooked and can include hot or cold sauces. For example, the recipe can include mayonnaise, hollandaise, béarnaise, or any other desired sauce.

FIG. 3 also shows that the method 300 can include preparing 304 the non-egg portion of the sauce according to the recipe. That is, all portions of the recipe other than the egg portion remain unchanged. One of skill in the art will appreciate that not all egg whites need to be removed. Thus, the method can be used with any desired recipe that contains eggs or any portion thereof without changing the taste or texture of the sauce. For example, standard mayonnaise requires, at its most basic level, an acid (often vinegar), mustard, oil and egg yolks (hollandaise and béarnaise are similar except the egg yolks are cooked). Other ingredients may be added, such as flavorings, preservatives or other desired ingredients.

FIG. 3 further shows that the method 300 can include adding 306 a compound containing saponins to the emulsion or sauce. The compound can include any desired saponins. For instance, the compound can include a mixture with between 25-50% w/w Quillaja saponaria extract soluble solids, between 0-25% w/w invert sugar as a carrier, between 50-75% w/w water and approximately 0.1% w/w sodium benzoate (food grade) as a preservative. The amount of compound to be added depends on the concentration of saponins within the compound. For example, if the compound is as described above then for each egg yolk replaced in the recipe ½ teaspoon of the compound are added to the sauce. As described above, not all egg whites or egg yolks need to be removed. For example, if the sauce requires 4 egg yolks then 2 egg yolks and 1 teaspoon of the compound can be used to create the sauce.

FIG. 3 additionally shows that the method 300 can include agitating 308 the sauce. Agitating can include shaking, stirring, pouring from a height, bubbling, blending or any other method that is configured to add air or other gases to the sauce. For example, using a stick blender or food processor or blender to agitate the sauce can fully mix in the compound containing saponins and create a creamy texture. One of skill in the art will appreciate that agitating need not occur immediately after preparation of the sauce. For example, the sauce can be prepared and chilled or frozen. After thawing agitation can occur.

By way of example, the method 300 of FIG. 3 can be used to create a mayonnaise. ½ tsp of Quillaja extract, 1 cup canola oil, 1 tbsp vinegar, 2 tsp lemon juice, ½ tsp dry mustard and a pinch of sea salt and sugar are added to a bowl. An immersion or stick blender is then used to mix the ingredients. Additional flavorings such as chili peppers or garlic can be added. Variations can be created by using other acids such as rice wine vinegar, champagne vinegar or any flavored vinegar; other acid juices such as lemon, lime, orange, grapefruit, pomegranete juice and other oils such as safflower, sunflower, olive, vegetable, soybean, sesame, peanut oils,

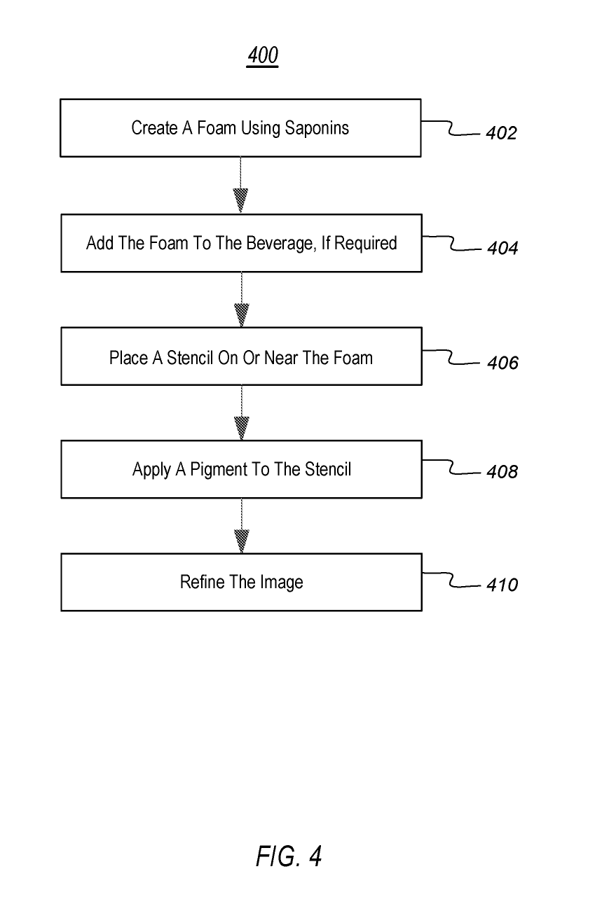

FIG. 4 is a flowchart illustrating an example of a method 400 of using saponins to create a stencil image on foam. In particular, the method 400 allows for an addition of image(s) to be added to the foam. Additionally, the stenciling can incorporate flavoring into the foam, which would collapse a foam created without saponins. I.e., the resultant image can be flavored allowing more complex beverages to be created.

FIG. 4 shows that the method 400 can include creating 402 a foam using saponins. The foam can be created 402 using the method 100 of FIG. 1 or using some other method. For example, the foam can be created by adding a gas (such as CO2, NO2, steam—either wet or dry, or some other gas) to a medium. In particular, the foam can be created 402 as part of the beverage or separately from the beverage to be added at a later time. For example, in espresso drinks, like a cappuccino or macchiato, the foam can be created in milk (i.e., the milk can be frothed) then added to the beverage.

FIG. 4 also shows that the method 400 can include adding 404 the foam to the beverage, if required. That is, if the foam was created 402 independent of the beverage then the foam is added 404 either by placing the foam on top of the beverage or pouring the foam into the beverage.

FIG. 4 further shows that the method 400 can include placing 406 a stencil on or near the foam. A stencil is an object with designed gaps in it which create the pattern or image by only allowing a pigment to reach some parts of the surface. The stencil is both the resulting image or pattern and the intermediate object; the context in which stencil is used makes clear which meaning is intended. Because the foam is denser and more stable when created 402 with saponins the stencil can be placed on the foam if required. That is, contact of the stencil with the foam is less likely to damage the foam containing saponins than a foam which is saponin free. Thus, more elaborate or detailed stencils can be used (since distance between the foam and the stencil causes the resultant image to lose resolution). Alternatively, the stencil can be placed on top of the cup or otherwise placed relative to the foam.

FIG. 4 additionally shows that the method 400 can include applying 408 a pigment to the stencil. For example, a liquid containing the pigment can be sprayed onto the stencil. Because the foam is stable the pigment does less or no damage to the foam relative to a foam that lacks saponins. That is, the addition of liquid containing pigment to the foam does not damage the foam, which both preserves the foam, allows for a better image, and prevents image bleed.

FIG. 4 moreover shows that the method 400 can include refining 410 the image. For example, additional stenciling can be performed, details can be added, portions of foam can be removed or any other desired changes can be made. A stable foam with higher density can allow greater detail in the image whereas foam without saponins collapses when refining 410 is attempted.

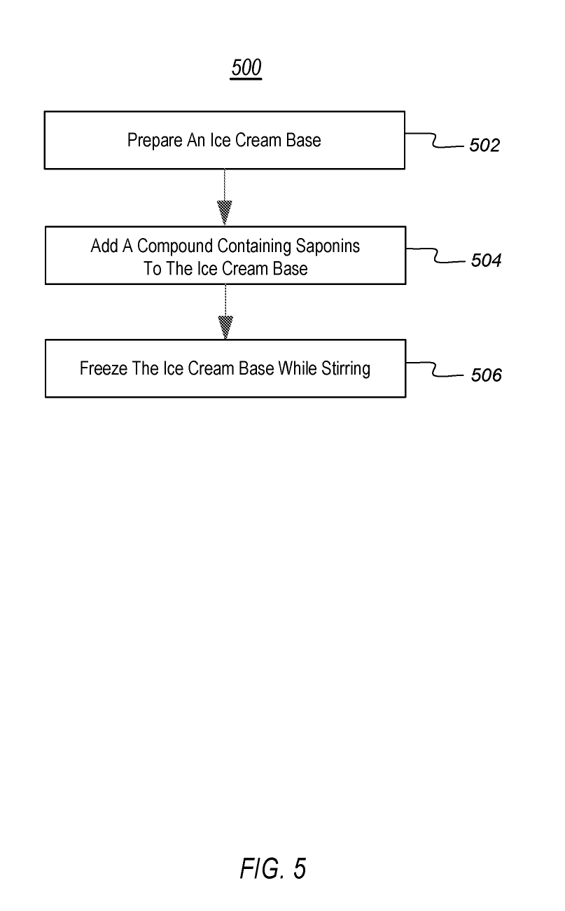

FIG. 5 is a flowchart illustrating an example of a method 500 of creating an ice cream using saponins. Because the saponins prevent the formation of large ice crystals, bind to the fat easily in ice cream and allow for more incorporation of air, the resulting ice cream is smoother, lighter and has a better mouthfeel.

FIG. 5 shows that the method 500 can include preparing 502 an ice cream base. The ice cream base is the mixture before freezing. I.e., it is the liquid mixture prepared 502 according to a recipe that can later be frozen to create an ice cream. Preparing 502 an ice cream base can optionally include subjecting the base to indirect sonification (methods of indirect sonification are provided in U.S. Non-Provisional patent application Ser. No. 15/010,191 filed on Jan. 29, 2016, which claims priority to U.S. Provisional Patent Application Ser. No. 62/109,518 filed on Jan. 29, 2015 both of which applications are incorporated herein by reference in their entirety). Indirect sonification improves the mixing of the ingredients improving the texture and mouthfeel of the resultant ice cream. For example, indirect sonification increases the blending of alcohol with the fat in the dairy mixture to form liposomes and nanoparticles, which lower the freezing point of the mixture and therefore decreases the amount of ice crystals formed.

FIG. 5 also shows that the method 500 can include adding 504 a compound containing saponins to the ice cream base. The compound can include any desired saponins, such as Quillaja extract. For example, the compound can include a mixture with between 25-50% w/w Quillaja saponaria extract soluble solids, between 0-25% w/w invert sugar as a carrier, between 50-75% w/w water and approximately 0.1% w/w sodium benzoate (food grade) as a preservative. The amount of compound to be added depends on the concentration of saponins within the compound. For example, if the compound is as described above then between ½ and 1 teaspoons of the compound can be added per quart of base. Quillaja extract or other triterpene saponins act as a foaming and emulsifying agent and forms micelles to incorporate up to 45% alcohol to allow freezing when added to a cream mixture. Typically, the compound is added after indirect sonification to prevent foaming during the sonification process.

Liposomes are spherical vessels of various sizes that can be created from fat to encapsulate other aqueous compounds, such as alcohols or drugs in order to deliver them across a membrane. Liposomes act as a delivery system with a bilayer of water loving charges (hydrophilic) on one side and water rejecting charges (hydrophobic) on the opposite side. Liposomes can be surfactants or phospholipids. Quallija is a saponin surfactant derived from the soap tree bark and as such can form micelles, a ball-like structure that reduces the surface tension. Saponins can adhere quickly to the droplet of alcohol, surround it so that nothing can penetrate the micelle and keeps the alcohol in very small particle sizes. This prevents the Ostwald reaction from occurring, which would result in a granular, icy texture to ice cream, especially when any alcohol has been added and the product has been defrosted even in small amounts and then refrozen. Hydrophobic elements (fat) can be incorporated into the phospholipid layer of the liposome, while hydrophilic elements (alcohol) can be incorporated within the micelle of the surfactant. This combination results in a synergistic response in ice cream, preventing crystallization while protecting the alcohol from dissolving in the water present in the dairy component.

FIG. 5 further shows that the method 500 can include freezing 506 the ice cream base while stirring. The ice cream base is stirred or churned during freezing to prevent the formation of large ice crystals. I.e., the physical stresses of stirring during the freezing process creates a mechanical force that breaks large ice crystals. Additionally, the saponins prevent large crystals from forming, both because it interrupts the crystals and because the resultant foaming incorporates air into the finished ice cream.

By way of example, and not by limitation, ice cream can be created using the method 400 of FIG. 4 as follows:

A base is composed of 14 oz sweetened condensed milk to which 1 cup of 4% milk is added and ½-1 cup of heavy whipping cream. A pinch of salt is added to aid in lowering the freezing point. 1½ cups of a cream liquor is added to the mixture (the type of alcohol and amount varies by the ABV, higher ABV up to 40% requires more heavy whipping cream and more quaillaja extract). The mixture is placed in a glass jar and put in a water bath with only a minimal amount of water. The jar is sealed and indirect sonication is performed using the sweep mode set for 15 minutes without any temperature setting. After sonication, 12 drops of the quaillaja extract are added and the mixture is then whipped before freezing to increase the foaming properties. The cream mixture is then either refrigerated or continues to the freezing process. This results in an extremely smooth, crystal free ice cream with no separation of the alcohol component. Furthermore, the mixture can be refrozen numerous times without loss of texture or integrity

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for creating a foam in alcoholic and non-alcoholic beverages, the method comprising:
providing a recipe for a beverage that includes egg whites as an ingredient;
preparing the non-egg white portion of the beverage according to the recipe;
adding a compound containing saponins to the beverage; and
agitating the beverage;
wherein the foam incorporates the liquid of the beverage.

2. The method of claim 1, wherein agitating the beverage includes stirring the beverage.

3. The method of claim 1, wherein agitating the beverage includes shaking the beverage.

4. The method of claim 1, wherein agitating the beverage includes pouring the beverage from a height.

5. The method of claim 1, wherein agitating the beverage includes using a blender or food processor to mix the beverage.

6. The method of claim 1 further comprising adding sugar to the beverage.

7. The method of claim 6, wherein adding sugar to the beverage includes adding syrup to the beverage.

8. The method of claim 1, wherein the compound containing saponins includes Quillaja extract.

9. The method of claim 8, wherein the compound includes between 25-50% w/w Quillaja saponaria extract soluble solids.

10. The method of claim 1, wherein approximately 2-4 drops of the compound are added to the beverage for every egg white in the recipe being replaced.

11. The method of claim 1, wherein only a portion of the egg whites in the recipe are being replaced.

12. A method for creating stencils on a foam, the method comprising:
creating a foam in a beverage using saponins;
placing a stencil on or near the foam; and
applying a pigment to the stencil.

13. The method of claim 12, wherein creating a foam in a beverage includes:
creating the foam independent of the beverage; and
adding the foam to the beverage.

14. The method of claim 13, wherein adding the foam to the beverage includes:
placing the foam on top of the beverage.

15. The method of claim 13, wherein adding the foam to the beverage includes:
pouring the foam into the beverage.

16. The method of claim 12 further comprising:
refining the image.

17. A method for creating ice cream, the method comprising:
preparing an ice cream base;
adding a compound containing saponins to the ice cream base; and
freezing the ice cream base while stirring.

18. The method of claim 17, wherein preparing an ice cream base includes:
adding an alcohol to the ice cream base.

19. The method of claim 17, wherein preparing an ice cream base includes:
Indirect sonification of the ice cream base.

20. The method of claim 17, wherein the compound containing saponins includes Quillaja extract.
